(19) United States
(12) Patent Application Publication
(10) Pub. No.: US 2007/0008620 A1
(43) Pub. Date: Jan. 11, 2007

(54) Switchable autostereoscopic display

(75) Inventors: Sergey Shestak, Suwon-si (KR); Dae-sik Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/361,961

(22) Filed: Feb. 27, 2006

(30) Foreign Application Priority Data
Jul. 11, 2005 (KR) 10-2005-0062129

(51) Int. Cl. G02B 27/22

(52) U.S. Cl. 359/463

(57) ABSTRACT

A switchable autostereoscopic display which can easily switch between a two-dimensional (2D) mode and a three-dimensional (3D) mode using a transparent elastic member is provided. The switchable autostereoscopic display includes a display panel which displays an image; a lenticular lens sheet which separates the image into a left-eye image and a right-eye image; a transparent substrate having a side which faces the lenticular lens sheet; and a transparent elastic member attached to the transparent substrate on the side of the transparent substrate that faces the lenticular lens sheet.

### CROSS-REFERENCE TO RELATED APPLICATION

This application claims the benefit of Korean Patent Application No. 10-2005-0062129, filed on Jul. 11, 2005, in the Korean Intellectual Property Office, the disclosure of which is incorporated herein in its entirety by reference.

### BACKGROUND OF THE INVENTION

1. Field of the Invention

Apparatuses consistent with the present invention relate to a switchable autostereoscopic display, and more particularly, to a switchable autostereoscopic display which can easily switch between a two-dimensional (2D) mode and a three-dimensional (3D) mode using a transparent elastic member.

2. Description of the Related Art

Autostereoscopic displays separate an image for a left eye and an image for a right eye and respectively display the separated images to provide binocular parallax to a user's left eye and right eye. The user perceives the left-eye image and the right-eye image provided from the autostereoscopic displays through the retinas of the two eyes to see a stereoscopic image. Autostereoscopic displays are roughly classified into parallax barrier displays and lenticular displays. In general, lenticular displays include a display panel displaying an image for a right eye and an image for a left eye, and a lenticular element installed in front of the display panel for separating viewing zones of a left-eye image and a right-eye image.

Demands for two-dimension/three dimension (2D/3D) switchable autostereoscopic displays, which can selectively provide a 2D image or a 3D image according to a displayed image signal, have recently increased. Thus, various 2D/3D switchable autostereoscopic displays have been developed.

For example, U.S. Pat. No. 5,500,765 discloses an autostereoscopic display including a lenticular sheet and a complementary lens sheet. The complementary lens sheet is placed on the lenticular sheet in a 2D mode to remove light refracting characteristics of the lenticular sheet, whereas the complementary lens sheet is removed from the lenticular sheet in a 3D mode to allow incident light to be refracted. However, the complementary lens sheet must be completely removed in the 3D mode so that light emitted from the lenticular sheet does not pass through the complementary lens sheet. If the complementary lens sheet is mounted on a hinge member, the complementary lens sheet must be rotated by an angle greater than 90°. Accordingly, the conventional autostereoscopic display is susceptible to shocks or vibrations.

Additionally, U.S. Pat. No. 6,069,650 discloses an autostereoscopic display which switches between a 2D mode and a 3D mode based on a change in the refractive index of an electro-optical medium. However, since the refractive index of the electro-optical medium can be controlled only for polarized light, the conventional autostereoscopic display can be applied only to a display panel, such as a liquid crystal display panel (LCD), which generates polarized light, and cannot be applied to a display panel, such as a cathode ray tube (CRT) display panel, a plasma display panel (PDP), an organic light emitting diode (OLED) display panel, or a field emission display (FED) panel, which generates unpolarized light.

To solve this problem, U.S. Patent Application Publication No. 2003-0085850 discloses an autostereoscopic display which switches between a 2D mode and a 3D mode by introducing/discharging a refractive index matching fluid into/from a reservoir.

FIG. 1 is a cross-sectional view of the conventional autostereoscopic display disclosed in U.S. Patent Application Publication No. 2003-0085850. Referring to FIG. 1, an autostereoscopic display 10 includes a backlight unit 11, an LCD panel 12 comprising a plurality of pixels, and switching means 20 which transmits incident light when it is in a 2D mode and separates a left-eye image and a right-eye image in a 3D mode. The switching means 20 includes a reservoir 21 made of a transparent material. A lenticular lens 23 is formed on a bottom surface 22 of the reservoir 21. A black mask 24 through which an image is not emitted is coated along an edge of a top surface of the reservoir 21.

In this structure, as shown on the right side of FIG. 1, the reservoir 21 has an empty space 26 in a 3D mode, such that an image emitted by the display panel 12 is separated into a left-eye image and a right-eye image due to the lenticular lens 23. However, as shown on the left side of FIG. 1, a fluid 25 having the same refractive index as that of the lenticular lens 23 is introduced into the reservoir 21 in a 2D mode. Then, since the lenticular lens 23 can no longer function as a lens, an image emitted by the display panel 12 is not refracted but passes through the reservoir 21.

However, when the fluid introduced into the reservoir 21 is discharged from the reservoir 21, the fluid may not be completely removed and some drops can remain inside the reservoir 21. In particular, a space between lens elements of the lenticular lens 23 may not be completely filled due to air bubbles produced when the fluid is introduced. When the fluid is discharged, some drops of the fluid may remain in the space between the lens elements of the lenticular lenses 23. In these cases, the image may be distorted or the left-eye image and the right-eye image may not be precisely separated. Furthermore, since a relatively long time is taken to introduce/discharge the fluid, a 2D/3D switching time increases. If the time taken to introduce/discharge the fluid is shortened, the amount of air bubbles generated in the fluid inevitably increases. Additionally, shocks or vibrations increase the possibility that air bubbles will be generated in the fluid.

### SUMMARY OF THE INVENTION

Apparatuses consistent with the present invention provide a two-dimension/three-dimension (2D/3D) switchable autostereoscopic display which can easily switch between a 2D mode and a 3D mode and is resistant to shocks or vibrations.

Apparatuses consistent with the present invention also provide a 2D/3D switchable autostereoscopic display which can minimize image distortion in a 2D mode and minimize light loss in a 3D mode.

Apparatuses consistent with the present invention also provide a 2D/3D switchable autostereoscopic display which can use a display panel emitting unpolarized light as well as a display panel emitting polarized light.

According to an aspect of the present invention, there is provided a 2D/3D switchable autostereoscopic display comprising a display panel which displays an image; a lenticular lens sheet which separates the image into a left-eye image and a right-eye image; a transparent substrate having a side which faces the lenticular lens sheet; and a transparent elastic member attached to the transparent substrate on the side of the transparent substrate that faces the lenticular lens sheet.

The transparent substrate may be flat, and the transparent elastic member and the lenticular lens sheet may have the same refractive index.

The lenticular lens sheet and the transparent elastic member may be separated from each other in a 3D mode, and the transparent elastic member may be pressed to the lenticular lens sheet in a 2D mode such that the surface of the transparent elastic member contacts the entire surface of the lenticular lens sheet. The transparent elastic member may be pressed to the lenticular lens sheet such that the transparent elastic member deforms.

The transparent substrate may be mounted on a side of the display panel so as to pivot about a hinge member.

The transparent substrate may pivot in the range of a first angle at which the lenticular lens sheet and the transparent elastic member are separated from each other and a second angle at which the surface of the transparent elastic member and the entire surface of the lenticular lens sheet contact each other.

A difference between the first angle and the second angle may be such that the first and the second angles do not exceed approximately ten degrees.

To prevent air bubbles from being generated between the transparent elastic member and the lenticular lens sheet in a 2D mode, contact between the transparent elastic member and the lenticular lens sheet may begin at an edge of an upper end of the lenticular lens sheet.

The axis of the hinge member that enables the transparent substrate to be pivotably coupled to the display panel may be perpendicular to lenticular lens elements of the lenticular lens sheet.

The transparent elastic member may be made of silicon resin.

### BRIEF DESCRIPTION OF THE DRAWINGS

The above and other aspects of the present invention will become more apparent by describing in detail certain exemplary embodiments thereof with reference to the attached drawings in which:

FIG. 1 is a cross-sectional view of a conventional two-dimensional/three-dimensional (2D/3D) switchable autostereoscopic display;

FIG. 2A is a cross-sectional view of a 2D/3D switchable autostereoscopic display, according to an exemplary embodiment of the present invention, which is in a 3D mode;

FIG. 2B is a cross-sectional view of the 2D/3D switchable autostereoscopic display of FIG. 2A in a 2D mode;

FIG. 3 is a perspective view of the 2D/3D switchable autostereoscopic display of FIG. 2A;

FIG. 4A is a longitudinal sectional view of the 2D/3D switchable autostereoscopic display of FIG. 2A which is in a 3D mode; and

FIG. 4B is a longitudinal sectional view of the 2D/3D switchable autostereoscopic display of FIG. 2A which is in a 2D mode.

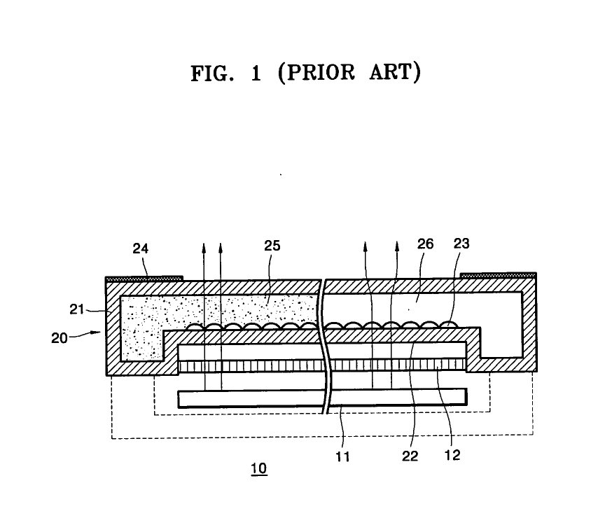

### DETAILED DESCRIPTION OF EXEMPLARY EMBODIMENTS OF THE INVENTION

The present invention will now be described more fully with reference to the accompanying drawings, in which exemplary embodiments of the invention are shown.

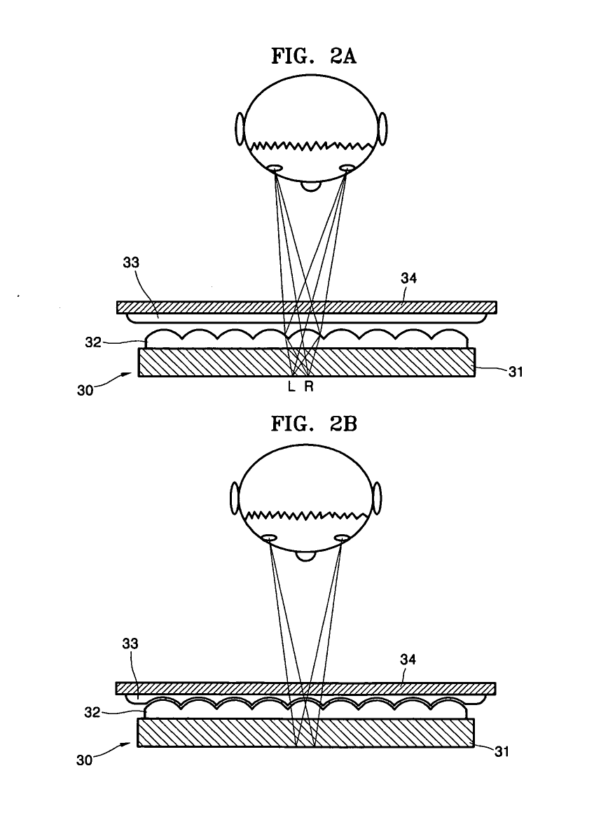

FIG. 2A is a cross-sectional view of a two-dimensional/three-dimensional (2D/3D) switchable autostereoscopic display, according to an exemplary embodiment of the present invention, which is in a 3D mode. FIG. 2B is a cross-sectional view of the 2D/3D switchable autostereoscopic display of FIG. 2A which is in a 2D mode. Referring to FIGS. 2A and 2B, an autostereoscopic display 30 includes a display panel 31 displaying an image, a lenticular lens sheet 32 formed on the display panel 31, a flat transparent substrate 34 facing the lenticular lens sheet 32, and a transparent elastic member 33 attached to a bottom surface of the transparent substrate 34 and facing the lenticular lens sheet 32.

The display panel 31 can be any display panel in which a plurality of pixels are arranged in rows and columns, such as a liquid crystal display (LCD) panel, a plasma display panel (PDP), an organic light emitting diode (OLED) display panel, a cathode ray tube (CRT) display panel, a field emission display (FED) panel, or other known display panel in the art.

The lenticular lens sheet 32 includes long cylindrical lenticular lens elements which are arranged in parallel. The lenticular lens sheet 32 is disposed over a display screen of the display panel 31. As is well known, the lenticular lens sheet 32 separates the image displayed by the display panel 31 into a left-eye image L and a right-eye image R according to its light refracting characteristics.

The transparent substrate 34 is made of a flat material such as glass, transparent plastic, or other such material known in the art, and faces the lenticular lens sheet 32. The transparent elastic member 33 is attached to the bottom surface of the transparent substrate 34 such that the transparent elastic member 33 also faces the lenticular lens sheet 32. The transparent elastic member 33 and the lenticular lens sheet 32 have substantially equal refractive indices, and the transparent elastic member 33 may be made of a material with high elasticity and restoring force. For example, the transparent elastic member 33 may be made of silicon resin, or other such material known in the art. The transparent elastic member 33 made of soft silicon resin has a flat, smooth surface, which is deformed when an external force is applied thereto and returns to its original flat state if the external force is removed.

When the autostereoscopic display 30 is in a 3D mode, as shown in FIG. 2A, the transparent substrate 34 and the transparent elastic member 33 are spaced apart from the lenticular lens sheet 32 by a predetermined distance. Accordingly, there is a space between the lenticular lens sheet 32 and the transparent elastic member 33. The right-eye images R are displayed with even (or odd) columns of pixels of the display panel, and the left-eye images L are displayed with odd (or even) columns of pixels of the display panel 31. Also, one lens in the lenticular lens sheet 32 covers two columns of pixels with which the left-eye image L and the right-eye image R are displayed. Then, the left-eye image L among the images displayed in the display panel 31 is refracted by the lens elements in the lenticular lens sheet 32, and then passes through the transparent elastic member 33 and the transparent substrate 34 to be incident on the left eye of a viewer 35. Likewise, the right-eye image R among the images displayed in the display panel 31 is refracted by the lens elements in the lenticular lens sheet 32, and then passes through the transparent elastic member 33 and the transparent substrate 34 to be incident on the right eye of the viewer 35. Accordingly, the viewer 35 can see a 3D image.

Alternatively, when the autostereoscopic display 30 is in a 2D mode, as shown in FIG. 2B, the transparent substrate 34 is moved toward the lenticular lens sheet 32, such that the transparent elastic member 33 is pressed to the lenticular lens sheet 32. When the transparent substrate 34 is moved a sufficient distance toward the lenticular lens sheet 32, the flat surface of the transparent elastic member 33 is deformed to completely contacting the entire surface of the lenticular lens sheet 32. Once contact occurs, the deformed surface of the lenticular lens sheet 32 has a complementary contour to the surface of the lenticular lens sheet 32 as shown in FIG. 2B. As described above, since the transparent elastic member 33 and the lenticular lens sheet 32 have the same refractive index, the lenticular lens sheet 32 and the transparent elastic member 33 may act as one flat sheet. As a result, the lenticular lens sheet 32 can no longer function as a lens, and light incident on the lenticular lens sheet 32 is not refracted but is transmitted through the lenticular lens sheet 32 and the transparent elastic member 33. The display panel 31 displays a 2D image, and images displayed with each column of pixels of the display panel 31 can be observed by the viewer 35 with both eyes simultaneously. Accordingly, the viewer 35 can see a 2D image.

The operation of moving the transparent elastic member 33 toward the lenticular lens sheet 32 or separating the transparent elastic member 33 from the lenticular lens sheet 32 can be performed in various ways. For example, the operation can be done manually using a mechanical device, or by an electromechanical device like a motor.

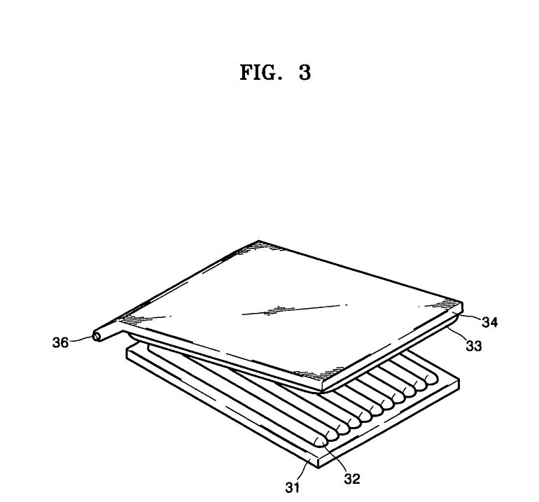

FIG. 3 is a perspective view of the 2D/3D switchable autostereoscopic display 30 of FIG. 2A, which includes 2D/3D switching means. Referring to FIG. 3, the transparent substrate 34 is mounted on an edge of the display panel 31 so as to pivot about a hinge member 36. The transparent elastic member 33 is moved toward the transparent substrate 34 to come into contact with the lenticular lens sheet 32 or is separated from the lenticular lens sheet 32 by pivoting the transparent substrate 34 about the hinge member 36.

Referring to FIG. 3, the axis of the hinge member 36, which enables the transparent substrate 34 to be pivotably coupled to the display panel 31, may be perpendicular to the lenticular lens elements constituting the lenticular lens sheet 32. That is, when longitudinal cylindrical lenticular lens elements are arranged in parallel to one another in a horizontal direction, the axis of the hinge member 36 is disposed in the horizontal direction in the vicinity of an edge of an upper end of the lenticular lens sheet 32. When the transparent substrate 34 is rotated to make the transparent elastic member 33 contact the lenticular lens sheet 32, the contact begins at the edge of the upper end of the lenticular lens sheet 32. If the transparent substrate 34 is rotated fully, the transparent elastic member 33 finally contacts a lower end of the lenticular lens sheet 32. Since the transparent elastic member 33 is gradually attached from the upper end to the lower end of the lenticular lens sheet 32 in this manner, air present between the lens elements of the lenticular lens sheet 32 can be mostly removed. Accordingly, when the transparent elastic member 33 and the lenticular lens sheet 32 completely contact each other, air bubbles are not generated between the transparent elastic member 33 and the lenticular lens sheet 32.

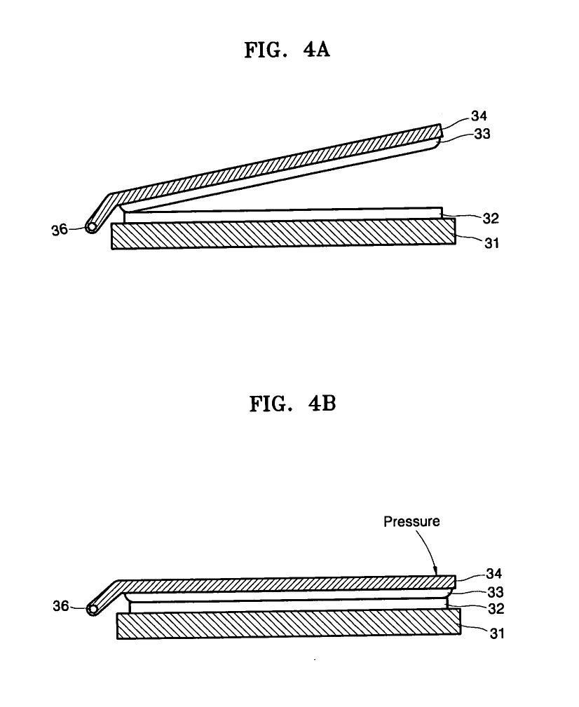

FIGS. 4A and 4B are longitudinal sectional views of the autostereoscopic display of FIG. 2A, with the hinge member 36 respectively illustrating the positions of the transparent substrate 34 in a 3D mode and a 2D mode. Referring to FIG. 4A, when the autostereoscopic display 30 is in a 3D mode, the transparent substrate 34 is disposed at a first angle so that the lenticular lens sheet 32 and the transparent elastic member 33 are separated from each other. Referring to FIG. 4B, when the autostereoscopic display 30 is in a 2D mode, the transparent substrate 34 is disposed at a second angle so that the surface of the transparent elastic member 33 is in close contact with the entire surface of the lenticular lens sheet 32. The transparent substrate 34 may pivot only in the range of the first angle and the second angle. Since the transparent substrate 34 and the transparent elastic member 33 do not change the propagation direction of light in a 2D mode, they do not affect the perception of a 2D image. Accordingly, the transparent substrate 34 does not need to be completely pulled back in a 2D mode. For example, a difference between the first angle and the second angle may not exceed approximately ten degrees.

As described above, the autostereoscopic display has a simple structure, and is resistant to shocks or vibrations. Also, image distortion or light loss due to air bubbles rarely occurs. Moreover, the autostereoscopic display can use a display panel emitting unpolarized light as well as a display panel emitting polarized light.

The 2D/3D switchable autostereoscopic display can be effectively applied to a mobile phone or a small display device.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A switchable autostereoscopic display comprising:
a display panel which displays an image;
a lenticular lens sheet which separates the image into a left-eye image and a right-eye image;
a transparent substrate having a side which faces the lenticular lens sheet; and
a transparent elastic member attached to the transparent substrate on the side of the transparent substrate that faces the lenticular lens sheet.

2. The switchable autostereoscopic display of claim 1, wherein the transparent elastic member and the lenticular lens sheet have respective refractive indices which are the same.

3. The switchable autostereoscopic display of claim 2, wherein the transparent substrate is flat.

4. The switchable autostereoscopic display of claim 2, wherein the lenticular lens sheet and the transparent elastic member are separated from each other in a three-dimensional (3D) mode, and the transparent elastic member is pressed to the lenticular lens sheet in a two-dimensional (2D) mode such that the surface of the transparent elastic member contacts an entire surface of the lenticular lens sheet.

5. The switchable autostereoscopic display of claim 4, wherein the transparent elastic member is pressed such that the transparent elastic member deforms.

6. The switchable autostereoscopic display of claim 2, wherein the transparent substrate is mounted on a side of the display panel so as to pivot about a hinge member.

7. The switchable autostereoscopic display of claim 6, wherein the transparent substrate pivots in a range of a first angle at which the lenticular lens sheet and the transparent elastic member are separated from each other and a second angle at which a surface of the transparent elastic member and an entire surface of the lenticular lens sheet contact each other.

8. The switchable autostereoscopic display of claim 7, wherein a difference between the first angle and the second angle does not exceed ten degrees.

9. The switchable autostereoscopic display of claim 6, wherein to prevent air bubbles from being generated between the transparent elastic member and the lenticular lens sheet in a two-dimensional mode, contact between the transparent elastic member and the lenticular lens sheet begins at an edge of an upper end of the lenticular lens sheet.

10. The switchable autostereoscopic display of claim 6, wherein an axis of the hinge member that enables the transparent substrate to be pivotably coupled to the display panel is perpendicular to lenticular lens elements of the lenticular lens sheet.

11. The switchable autostereoscopic display of claim 2, wherein the transparent elastic member is made of silicon resin.

12. The switchable autostereoscopic display of claim 2, wherein the
display panel comprises at least one of a liquid crystal display (LCD) panel, a plasma display panel (PDP), an organic light emitting diode (OLED) display panel, and a cathode ray tube (CRT) display panel.

13. An image display comprising:
a display panel which displays an image;
a lenticular lens sheet which separates the image into a left-eye image and a right-eye image;
a transparent substrate having a side which faces the lenticular lens sheet; and
a transparent elastic member attached to the transparent substrate on the side of the transparent substrate that faces the lenticular lens sheet.

14. The image display of claim 13, wherein the transparent elastic member and the lenticular lens sheet have respective refractive indices which are the same.

15. The image display of claim 13, wherein the transparent substrate is mounted on a side of the display panel to pivot about a hinge member so that the lenticular lens sheet and the transparent elastic member can be separated from each other, or the transparent elastic member can contact the lenticular lens sheet.

16. The image display of claim 15, wherein the transparent elastic member is pressed such that the transparent elastic member deforms.

17. The image display of claim 14, wherein the transparent substrate is mounted on a side of the display panel so as to pivot about a hinge member so that the lenticular lens sheet and the transparent elastic member can be separated from each other, or the transparent elastic member can be pressed to the lenticular lens sheet.

18. The image display of claim 17, wherein the transparent elastic member is pressed such that the transparent elastic member deforms.
